(19) United States
(12) Patent Application Publication
(10) Pub. No.: US 2026/0065095 A1
(43) Pub. Date: Mar. 5, 2026

(54) KNOWLEDGE QUESTION-ANSWERING METHOD, APPARATUS, READABLE MEDIUM, ELECTRONIC DEVICE, AND PROGRAM PRODUCT

(71) Applicant: Beijing Youzhuju Network Technology Co., Ltd., Beijing (CN)

(72) Inventors: Yongfu MA, Beijing (CN); Shaoyu ZHANG, Beijing (CN); Xuefeng LIU, Beijing (CN)

(21) Appl. No.: 19/299,961

(22) Filed: Aug. 14, 2025

(30) Foreign Application Priority Data
Aug. 29, 2024 (CN) 202411206272.7

(51) Int. Cl. G06N 5/04

(52) U.S. Cl. CPC G06N 5/04

(57) ABSTRACT

The present disclosure relates to a knowledge question-answering method, an apparatus, a readable medium, an electronic device, and a program product. The method includes: acquiring a target question input by a user in a natural language; retrieving, through a machine learning model, in a knowledge base according to the target question to obtain a target knowledge document for answering the target question, and determining, based on the target knowledge document, a target answer for the target question, wherein the knowledge base is used to store a business knowledge document; and displaying the target answer to the user.

### CROSS-REFERENCE TO RELATED APPLICATION

This application claims priority to Chinese Patent Application No. 202411206272.7, filed on Aug. 29, 2024, which is incorporated herein by reference in its entirety as a part of this application.

### TECHNICAL FIELD

The present disclosure relates to the technical field of computer, and in particular, to a knowledge question-answering method, an apparatus, a readable medium, an electronic device and a program product.

### BACKGROUND

When a user wants to know business knowledge in a specific field, the user generally retrieves a related document on various document retrieval platforms and then clicks on the document one by one for reading so as to check whether there is business knowledge related to the user's own requirement.

### SUMMARY

The Summary is provided to introduce concepts in a simplified form, and these concepts will be described in detail in the Detailed Description section below. The Summary is not intended to identify key features or essential features of the claimed technical solution, nor is it intended to be used to limit the scope of the claimed technical solution.

In a first aspect, the present disclosure provides a knowledge question-answering method, including:
acquiring a target question input by a user in a natural language;
retrieving, through a machine learning model, in a knowledge base according to the target question to obtain a target knowledge document for answering the target question, and determining, based on the target knowledge document, a target answer for the target question, where the knowledge base is used to store a business knowledge document; and
displaying the target answer to the user.

In a second aspect, the present disclosure provides a knowledge question-answering apparatus, including:
an acquisition module, configured to acquire a target question input by a user in a natural language;
a determination module, configured to retrieve, through a machine learning model, in a knowledge base according to the target question to obtain a target knowledge document for answering the target question, and determine, based on the target knowledge document, a target answer for the target question, where the knowledge base is used to store a business knowledge document; and
a display module, configured to display the target answer to the user.

In a third aspect, the present disclosure provides a computer-readable medium having a computer program stored thereon, where the computer program, when executed by a processing apparatus, implements the steps of the method according to any one of the first aspect.

In a fourth aspect, the present disclosure provides an electronic device, including:
a storage apparatus having a computer program stored thereon; and
a processing apparatus, configured to execute the computer program in the storage apparatus to implement the steps of the method according to any one of the first aspect.

In a fifth aspect, the present disclosure provides a computer program product, including a computer program, where the computer program, when executed by a processor, implements the steps of the method according to any one of the first aspect.

Other features and advantages of the present disclosure will be described in detail in the subsequent detailed description section.

### BRIEF DESCRIPTION OF DRAWINGS

The above and other features, advantages and aspects of embodiments of the present disclosure will become more apparent when taken in conjunction with the drawings and with reference to the following detailed description. Throughout the drawings, the same or similar reference numerals represent the same or similar elements. It should be understood that the drawings are schematic and that parts and elements are not necessarily drawn to scale. In the drawings:

FIG. 1 is a flowchart of a knowledge question-answering method according to an exemplary embodiment of the present disclosure;

FIG. 2 is a flowchart of constructing an intelligent object page according to an exemplary embodiment of the present disclosure;

FIG. 3 is a flowchart of another knowledge question-answering method according to an exemplary embodiment of the present disclosure;

FIG. 4 is a schematic diagram of a process of constructing a knowledge base according to an exemplary embodiment of the present disclosure;

FIG. 5 is a block diagram of a knowledge question-answering apparatus according to an exemplary embodiment of the present disclosure; and

FIG. 6 is a structural diagram of an electronic device according to an exemplary embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein, rather these embodiments are provided for a more thorough and complete understanding of the present disclosure. It should be understood that the drawings and embodiments of the present disclosure are only for illustrative purposes and are not intended to limit the protection scope of the present disclosure.

It should be understood that the steps described in the method implementations of the present disclosure may be performed in different orders and/or in parallel. In addition, the method implementations may include additional steps and/or omit performing the illustrated steps. The scope of the present disclosure is not limited in this respect.

The term “include/comprise” and its variants as used herein are open-ended inclusions, that is, “include/comprise but not limited to”. The term “based on” is “based at least in part on”. The term “one embodiment” means “at least one embodiment”; the term “another embodiment” means “at least one another embodiment”; and the term “some embodiments” means “at least some embodiments”. Related definitions of other terms will be given in the following description.

It should be noted that the concepts of “first” and “second” mentioned in the present disclosure are only used to distinguish between different apparatuses, modules or units, and are not used to limit the order or interdependence of the functions performed by these apparatuses, modules or units.

It should be noted that the modifications of “one” and “a plurality of” mentioned in the present disclosure are illustrative rather than restrictive, and those skilled in the art should understand that unless the context clearly indicates otherwise, they should be understood as “one or more”.

The names of messages or information exchanged between a plurality of apparatuses in the implementations of the present disclosure are only used for illustrative purposes, and are not used to limit the scope of these messages or information.

It can be understood that before using the technical solutions disclosed in the embodiments of the present disclosure, the user should be informed of the type, scope of use, usage scenario, etc. of the personal information involved in the present disclosure and the user's authorization should be obtained through an appropriate manner in accordance with relevant laws and regulations.

For example, in response to receiving an active request from the user, prompt information is sent to the user to explicitly prompt the user that the operation requested to be performed will require the acquisition and use of the user's personal information. In this way, the user can choose whether to provide personal information to software or hardware such as an electronic device, an application, a server, or a storage medium that performs the operation of the technical solution of the present disclosure according to the prompt information.

As an optional but non-limiting implementation, in response to receiving the active request from the user, the prompt information is sent to the user, for example, in the form of a pop-up window, and the prompt information may be presented in the form of text in the pop-up window. In addition, the pop-up window may also carry a selection control for the user to select “consent” or “disagree” to provide personal information to the electronic device.

It can be understood that the above process of notifying and obtaining user authorization is only illustrative and does not constitute a limitation to the implementations of the present disclosure, and other methods that meet relevant laws and regulations may also be applied to the implementations of the present disclosure.

Meanwhile, it may be understood that the data involved in the technical solution (including but not limited to the data itself, and the acquisition or use of the data) should comply with requirements of corresponding laws, regulations and relevant provisions.

As mentioned in the Background section, when a user wants to know business knowledge in a specific field, the user generally retrieves a related document on various document retrieval platforms and then clicks on the document one by one for reading to check whether there is the business knowledge related to the user's own requirement.

Exemplarily, business knowledge in different specific fields has certain thresholds and field barriers. For example, the same word may have different meanings in different fields. When the user wants to know the meaning represented by a certain word in a specific field, the user needs to input the word to retrieve a related knowledge document, and then click on the document one by one for reading to check whether there is related content explaining the word in the knowledge document. This not only results in low efficiency of acquiring knowledge, but also makes it easy to miss the related business knowledge.

In view of this, the present disclosure provides a knowledge question-answering method, an apparatus, a readable medium, an electronic device and a program product to solve the above technical problem.

The embodiments of the present disclosure will be further explained below with reference to the drawings.

FIG. 1 is a flowchart of a knowledge question-answering method according to an exemplary embodiment of the present disclosure. Referring to FIG. 1, the method may include the following steps.
S101: acquiring a target question input by a user in a natural language.

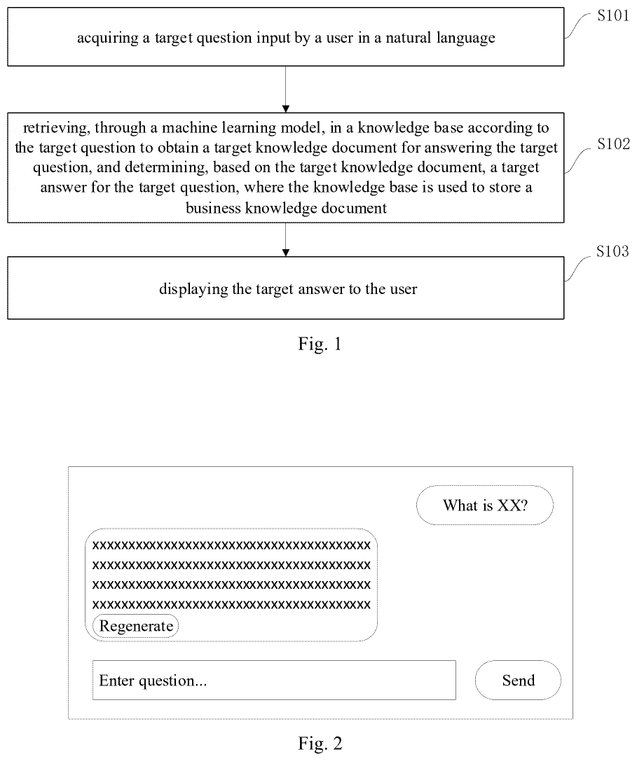

Exemplarily, for business platforms in different fields, a search box may be displayed on a platform page, and when the user performs an input operation in the search box, a target question input by the user in a natural language is acquired. Alternatively, an intelligent object may be displayed on the platform page, and by clicking on the intelligent object, an intelligent object page, as shown in FIG. 2, is displayed on the platform page. When the user performs an input operation on the intelligent object page, the target question input by the user in a natural language is acquired.
S102: retrieving, through a machine learning model, in a knowledge base according to the target question to obtain a target knowledge document for answering the target question, and determining, based on the target knowledge document, a target answer for the target question, where the knowledge base is used to store a business knowledge document.

Exemplarily, after the target question input by the user is acquired, the target question may be input into a pre-trained machine learning model, and the machine learning model retrieves, in the knowledge base according to the target question, a related knowledge document, and then obtains a question answer based on the knowledge document.

In the embodiment, the business knowledge document stored in the knowledge base may be determined according to actual situations, and the embodiments of the present disclosure do not impose any limitations in this respect. Exemplarily, a corresponding knowledge base may be constructed based on different fields, and the business knowledge document may include a structured data document or an unstructured data document, which is not limited in the embodiments of the present disclosure.
S103: displaying the target answer to the user.

In the embodiment, a display manner of displaying the target answer to the user may be set according to actual situations, and the embodiments of the present disclosure do not impose any limitations in this respect.

Through the above technical solutions, it is possible to first retrieve, through a machine learning model, in a knowledge base according to a target question input by a user to obtain a target knowledge document, and then determine, through the machine learning model and based on the target knowledge document, a target answer for the target question and display the target answer to the user. Thus, it is possible to understand, through the machine learning model, the question input by the user and perform automatic search and sorting of a knowledge document based on the question input by the user so as to directly present the answer to the question to the user. This can not only improve the accuracy and search efficiency of the user in retrieving a knowledge document in a specific field, but also directly obtain the answer to the question, thereby improving the efficiency of the user in knowing the business knowledge in the specific field.

To facilitate understanding of the solution, possible implementations in the present disclosure will be described below.

In a possible implementation, a plurality of target knowledge documents are provided, and the determining, based on the target knowledge document, a target answer for the target question includes: determining content relevance between the target question and each of the plurality of target knowledge documents; determining a preset number of knowledge documents from the plurality of target knowledge documents according to the content relevance, where the content relevance corresponding to each of the preset number of knowledge documents is greater than the content relevance corresponding to each of knowledge documents other than the preset number of knowledge documents in the plurality of target knowledge documents; and determining the target answer for the target question according to the preset number of knowledge documents.

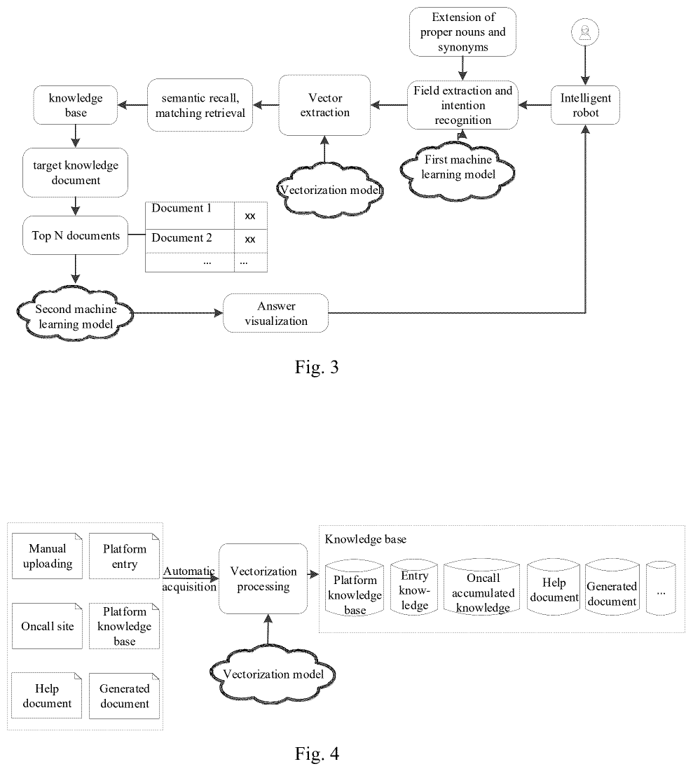

Exemplarily, as shown in FIG. 3, when a plurality of target knowledge documents are provided, for each of the target knowledge documents, the content relevance between the target question and the target knowledge document is determined, then the plurality of target knowledge documents are sorted based on the content relevance, a knowledge document with greater content relevance is selected, and then the target answer for the target question is determined based on the knowledge document with greater content relevance.

In the embodiment, the preset number of knowledge documents with greater content relevance may be selected, or the knowledge document with a relevance greater than a preset threshold may be selected, where the preset number and the preset threshold may be determined according to actual situations, and the embodiments of the present disclosure do not impose any limitations in this respect.

Exemplarily, for example, the preset number may be set to 10, and then the first 10 knowledge documents with greater content relevance are selected from the plurality of target knowledge documents. For another example, the preset threshold may be set to 80%, and then the knowledge documents with content relevance greater than 80% are selected from the plurality of target knowledge documents. In this way, the knowledge document with higher relevance to the target question may be further selected, thereby improving the accuracy of the target answer.

In a possible implementation, the determining content relevance between the target question and each of the target knowledge documents includes: inputting the target question and the plurality of target knowledge documents into a relevance model to obtain the content relevance between the target question and each of the target knowledge documents, where the relevance model is configured to output, according to an input question and an input knowledge document, content relevance between the input question and the input knowledge document.

Exemplarily, the content relevance between the target question and each of the target knowledge documents may be determined based on a pre-trained relevance model. The relevance model may be an existing relevance model in the related art, or a relevance model obtained by improving an existing relevance model in the related art. In addition, the relevance model may be a separate model or a sub-model in a machine learning model, which is not limited in the embodiments of the present disclosure.

In a possible implementation, the determining, based on the target knowledge document, a target answer for the target question includes: generating a target prompt based on the target knowledge document, the target question and a preset prompt template, where the target prompt is used to instruct the machine learning model to determine, based on the target knowledge document, the target answer for the target question; and inputting the target prompt into the machine learning model to obtain the target answer for the target question.

In the embodiment, the prompt template may be set according to actual situations, and the embodiments of the present disclosure do not impose any limitations in this respect. Exemplarily, the prompt template may be set as follows: please generate a structured answer for extracting a corresponding question from a knowledge document corresponding to a document identification based on “query question: XXXX and document identification: XXXX”.

In the embodiment, the prompt template is preset, so that after the query question and the document identification of the target knowledge document are obtained, the query question and the document identification may be directly filled into corresponding positions of the prompt template, so that the target prompt text may be quickly generated, thereby improving the generation speed of the structured answer and improving the user experience.

In the embodiment, as shown in FIG. 2, the target answer may be displayed on a display page, and a re-generation control “Regenerate” is displayed beside the target answer, and by clicking on “Regenerate”, the retrieval of the knowledge document and the generation of the target answer are re-performed based on the target question.

Through the above manner, the interactive control for triggering the user to re-generate the answer corresponding to the target question may be displayed while displaying the target answer to the user, so that the answer may be re-generated according to the target answer and the actual requirement of the user, thereby further improving the accuracy of the target answer.

In a possible implementation, the retrieving, through a machine learning model, in a knowledge base according to the target question to obtain a target knowledge document for answering the target question includes: extracting, through the machine learning model, a key field in the target question; performing, at least according to the key field, a semantic recall in the knowledge base to obtain a first knowledge document, where the semantic recall is used to query a knowledge document including a first similar field in the knowledge base, and a semantic similarity between the first similar field and the key field is greater than a preset threshold; and performing, at least according to the key field, a matching retrieval in the knowledge base to obtain a second knowledge document, where the matching retrieval is used to query a knowledge document including the key field in the knowledge base; correspondingly, the target knowledge document includes the first knowledge document and the second knowledge document.

Exemplarily, the semantic recall is used to query a knowledge document including a similar field in the knowledge base. For example, field similarity may be calculated through cosine similarity, and then the knowledge document including the similar field with the similarity greater than the preset threshold is used as the first knowledge document. The matching retrieval is used to retrieve a knowledge document including the key field in the knowledge base. For example, the number of key fields in each knowledge document including the key field may be counted, and then the knowledge document with the large number of the key fields is selected as the second knowledge document. Alternatively, scores may be set in advance for different intervals of the number of the fields, and then the corresponding score is determined according to the number of the key fields, and then the knowledge document with a high score is selected as the second knowledge document. The specific determination may be made according to requirements, and the embodiments of the present disclosure do not impose any limitations in this respect.

Exemplarily, the knowledge fragment in the knowledge base may be stored in the form of an embedding vector. Therefore, as shown in FIG. 3, the key field may be input into a pre-trained vectorization model, so as to obtain a corresponding target embedding vector. After the target embedding vector is obtained, the semantic recall or the matching retrieval is performed in the knowledge base based on the target embedding vector.

It should be noted that a correspondence between the document identification and the knowledge fragment vector may also be pre-stored in the knowledge base, so that after the knowledge fragment vector corresponding to the key field is determined, the corresponding document identification is determined based on the correspondence, and then the target knowledge document corresponding to the document identification is acquired.

It should be understood that the above is only illustrative and does not constitute a limitation to the solution. In a possible implementation, the machine learning model that extracts the key field of the target question and the machine learning model that performs the vectorization processing on the key field may be the same machine learning model.

Through the above manner, the document search may be performed in the knowledge base based on the two methods of semantic recall and matching retrieval. Since the semantic recall is used to query a similar field with semantic similarity greater than the preset threshold in the knowledge base, and the semantic similarity is a similarity between the similar field and the key field, it is possible to find the knowledge document including the field that is semantically similar to the key field, thereby increasing the recall breadth. The matching retrieval can quickly locate the knowledge document including the key field, thereby realizing more accurate and more efficient data retrieval.

In the embodiment, as shown in FIG. 3, the intention recognition and the extraction of the key field may be performed on the target question based on a first machine learning model, and the keyword expansion may also be performed based on the first machine learning model, which is not limited in the embodiments of the present disclosure.

In a possible implementation, the method further includes: determining an expansion word with the same semantics as the key field. The performing, at least according to the key field, a semantic recall in the knowledge base includes: performing, according to the key field and the expansion word, the semantic recall in the knowledge base, where the semantic recall is used to query a knowledge document including a second similar field in the knowledge base, and a semantic similarity between the second similar field and the key field is greater than the preset threshold, or a semantic similarity between the second similar field and the expansion word is greater than the preset threshold. The performing, at least according to the key field, a matching retrieval in the knowledge base includes: performing, according to the key field and the expansion word, the matching retrieval in the knowledge base, where the matching retrieval is used to retrieve a knowledge document including the key field or the expansion word in the knowledge base.

Exemplarily, the key field is “consumption”, and the expansion word with the same semantics as “consumption” determined in the preset lexicon is “cost”. Therefore, the matching retrieval may be performed in the knowledge base based on “consumption” and “cost”, respectively. If the knowledge document A is matched in the knowledge base based on “consumption”, and the knowledge document B is matched in the knowledge base based on “cost”, the target knowledge document is obtained.

Exemplarily, the key field is “consumption”, and the expansion word with the same semantics as “consumption” determined in the preset lexicon is “cost”. Therefore, the semantic recall may be performed in the knowledge base based on the semantics of “consumption” and “cost”, respectively. If the knowledge document C is recalled in the knowledge base based on the semantics of “consumption”, and the knowledge document D is recalled in the knowledge base based on the semantics of “cost”, the target knowledge document is obtained.

Exemplarily, the key field is “consumption”, and the expansion word with the same semantics as “consumption” determined in the preset lexicon is “cost”. Therefore, the matching retrieval and the semantic recall may be performed in the knowledge base based on “consumption” and “cost”, respectively. If the knowledge document A is matched in the knowledge base based on “consumption”, the knowledge document B is matched in the knowledge base based on “cost”, the knowledge document C is recalled in the knowledge base based on the semantics of “consumption”, and the knowledge document D is recalled in the knowledge base based on the semantics of “cost”, the target knowledge document is obtained.

Through the above manner, the expansion word with the same semantics as the key field may be acquired, so that the search is performed in the knowledge base based on the key field and the expansion word. Since the expansion word has the same semantics as the key field, the relevance and accuracy of the search result may be improved.

The implementation of the solution in the embodiment may refer to the related description of the semantic recall and the matching retrieval in the knowledge base based on the key field, which will not be repeated here. The target knowledge document may refer to the entire knowledge document or a knowledge document fragment, which is not limited in the embodiments of the present disclosure.

It should be understood that the manner of performing the search in the knowledge base according to the key field and the expansion word in the embodiment is only illustrative and does not constitute a limitation to the solution. When the knowledge fragment in the knowledge base is stored in the form of an embedding vector, in a possible implementation, after the embedding vectors corresponding to the key field and the expansion word are determined, the matching retrieval may be performed in the knowledge base according to the embedding vectors corresponding to the key field and the expansion word. And/or, the semantic recall is performed in the knowledge base according to the embedding vectors corresponding to the key field and the expansion word.

In a possible implementation, the business knowledge document in the knowledge base is stored in the following manner: acquiring a plurality of business knowledge documents through different channels; performing a splitting processing on each of the business knowledge documents to obtain a business knowledge fragment; performing a vectorization processing on the business knowledge fragment to obtain a knowledge fragment vector; and storing the knowledge fragment vector into the knowledge base.

Exemplarily, as shown in FIG. 4, the document uploaded by the user in the business platform, the entry content defined by the platform, the platform knowledge base generated based on the document in the platform, the help document for the external of the platform, the oncall site, that is, the question and answer content manually maintained, and the document automatically generated based on a plurality of documents, etc. may be acquired, which may be specifically determined according to actual business scenarios and is not limited in the embodiments of the present disclosure. Further, the acquired business knowledge document may be split to obtain the business knowledge fragment.

In the embodiment, the corresponding knowledge base may be constructed for different fields, for example, the field of e-commerce, etc., which is not limited in the embodiments of the present disclosure. The business knowledge document may be stored in the knowledge base in the form of a natural language or in the form of an embedding vector, which is not limited in the embodiments of the present disclosure. If it is stored in the form of a natural language, it is stored in the knowledge base after the business knowledge fragment is obtained. If it is stored in the form of an embedding vector, the vectorization processing may be performed on the business knowledge fragment through a vectorization model, and the obtained knowledge fragment vector is stored.

In a possible implementation, the retrieving, through a machine learning model, in a knowledge base according to the target question to obtain a target knowledge document for answering the target question, and determining, based on the target knowledge document, a target answer for the target question includes: retrieving, through a first machine learning model, in the knowledge base according to the target question to obtain the target knowledge document for answering the target question; and determining, through a second machine learning model and based on the target knowledge document, the target answer for the target question.

In the embodiment, as shown in FIG. 3, the first machine learning model and the second machine learning model may be different models or different sub-models in the same machine learning model, which is not limited in the present disclosure. Correspondingly, the vectorization model disclosed in the embodiments of the present disclosure may be another model different from the machine learning model or a sub-model integrated in the machine learning model. For example, the vectorization model shown in FIG. 4 and the first machine learning model are different sub-models of the same machine learning model, or the same machine learning model integrates the vectorization models shown in FIG. 3 and FIG. 4, and the first machine learning model and the second machine learning model, which is not limited in the embodiments of the present disclosure.

The first machine learning model may be an existing machine learning model in the related art or a machine learning model obtained by improving an existing machine learning model in the related art. The embodiments of the present disclosure do not impose any limitations in this respect. Exemplarily, the first machine learning model may be a Transformer model in the related art. Therefore, the Transformer model may be trained by constructing a training sample, so that the Transformer model can realize accurate extraction of a knowledge document based on a target question.

Exemplarily, a sample statement marked with label and used to query a knowledge document may be acquired, where the label is used to indicate a key field of the sample statement, the sample statement is input into the Transformer model to obtain a predicted key field, a loss function value of a real key field and the predicted key field is calculated, and a parameter value of the Transformer model is adjusted based on the loss function value until the Transformer model converges.

The second machine learning model may be an existing machine learning model in the related art or a machine learning model obtained by improving an existing machine learning model in the related art. The embodiments of the present disclosure do not impose any limitations in this respect. Exemplarily, the second machine learning model may be a Large Language Model (LLM) in the related art. Therefore, the LLM model may be trained by constructing a training sample, so that the LLM model can output a structured question answer according to an input prompt.

Exemplarily, a sample prompt marked with label may be acquired, where the label is used to indicate a real structured question answer corresponding to the sample prompt, the sample prompt is input into the LLM model to obtain a predicted structured question answer, a loss function value of the real structured question answer and the predicted structured question answer is calculated, and a parameter value of the LLM model is adjusted based on the loss function value until the LLM model converges.

To facilitate understanding of the knowledge question-answering method of the present disclosure, a possible implementation of the solution will be described below.

As shown in FIG. 2, an intelligent object is displayed on a platform page, and by clicking on the intelligent object, an intelligent object page is displayed on the platform page. After the user inputs a target question “what is XX” in a natural language on the intelligent object page, “what is XX” is input into a first machine learning model at a backend of the platform, and the first machine learning model performs intention recognition and key field extraction on “what is XX” to obtain a key field “XX”. Then, a proper noun and/or a synonym expansion is performed in a preset lexicon based on the semantics of “XX” to obtain an expansion word “XXX”. After the expansion word “XXX” is obtained, vectorization processing is performed by the first machine learning model based on “XX” and “XXX”, and then matching retrieval and semantic recall are performed in a knowledge base to obtain a target knowledge document. Then, relevance between the target question and the target knowledge document is determined through a relevance model, a knowledge document with higher relevance is determined therefrom, and a document identification corresponding to the knowledge document and the target question are filled into corresponding positions of a prompt template to obtain a target prompt text, and the target prompt text is input into a second machine learning model to obtain a structured answer for extracting a corresponding question from the knowledge document corresponding to the document identification.

By using the above method, the machine learning model is used to recognize and understand the question input by the user, and extract the key field in the question, so as to improve the accuracy of recalling the user's related question. Then, by combining the technologies of document fragment splitting, vectorization, and semantic retrieval, the accuracy of recalling the document related to the user's question can be improved. Then, the related document fragment is sent to the machine learning model for answering, so that the user can directly obtain the answer to the question. This can not only improve the accuracy and search efficiency of the user in retrieving a knowledge document in a specific field, but also directly obtain the answer to the question, thereby improving the efficiency of the user in knowing the business knowledge in the specific field.

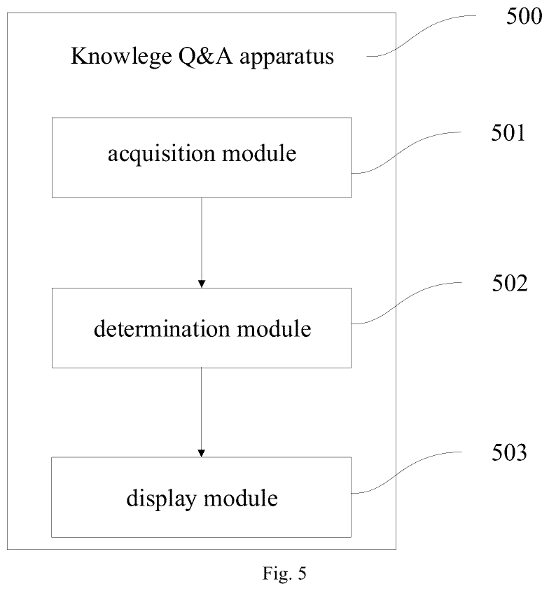

Based on the same concept, an embodiment of the present disclosure further provides a knowledge question-answering apparatus. As shown in FIG. 5, the knowledge question-answering apparatus 500 may include:
an acquisition module 501, configured to acquire a target question input by a user in a natural language;
a determination module 502, configured to retrieve, through a machine learning model, in a knowledge base according to the target question to obtain a target knowledge document for answering the target question, and determine, based on the target knowledge document, a target answer for the target question, where the knowledge base is used to store a business knowledge document; and
a display module 503, configured to display the target answer to the user.

Through the above knowledge question-answering apparatus 500, it is possible to first retrieve, through a machine learning model, in a knowledge base according to a target question input by a user to obtain a target knowledge document, and then determine, through the machine learning model and based on the target knowledge document, a target answer for the target question and display the target answer to the user. Thus, it is possible to understand, through the machine learning model, the question input by the user and perform automatic search and sorting of a knowledge document based on the question input by the user so as to directly present the answer to the question to the user. This can not only improve the accuracy and search efficiency of the user in retrieving a knowledge document in a specific field, but also directly obtain the answer to the question, thereby improving the efficiency of the user in knowing the business knowledge in the specific field.

In a possible implementation, a plurality of target knowledge documents are provided, and the determination module 502 may include:
a first determination sub-module, configured to determine content relevance between the target question and each of the target knowledge documents;
a second determination sub-module, configured to determine a preset number of knowledge documents from the plurality of target knowledge documents according to the content relevance, where the content relevance corresponding to the preset number of knowledge documents is greater than that of knowledge documents other than the preset number of knowledge documents in the plurality of target knowledge documents; and
a third determination sub-module, configured to determine the target answer for the target question according to the preset number of knowledge documents.

In a possible implementation, the first determination sub-module is configured to:
input the target question and the plurality of target knowledge documents into a relevance model to obtain the content relevance between the target question and each of the target knowledge documents, where the relevance model is configured to output, according to an input question and an input knowledge document, content relevance between the input question and the input knowledge document.

In a possible implementation, the determination module 502 may include:
a generation module, configured to generate a target prompt based on the target knowledge document, the target question and a preset prompt template, where the target prompt is used to instruct the machine learning model to determine, based on the target knowledge document, the target answer for the target question; and
an input module, configured to input the target prompt into the machine learning model to obtain the target answer for the target question.

In a possible implementation, the determination module 502 may include:
an extraction module, configured to extract a key field in the target question through the machine learning model;
a recall module, configured to perform, at least according to the key field, a semantic recall in the knowledge base to obtain a first knowledge document, where the semantic recall is used to query a knowledge document including a first similar field in the knowledge base, and a semantic similarity between the first similar field and the key field is greater than a preset threshold; and
a retrieval module, configured to perform, at least according to the key field, a matching retrieval in the knowledge base to obtain a second knowledge document, where the matching retrieval is used to query a knowledge document including the key field in the knowledge base;
where the target knowledge document includes the first knowledge document and the second knowledge document.

In a possible implementation, the knowledge question-answering apparatus 500 further includes:
a fourth determination sub-module, configured to determine an expansion word with the same semantics as the key field;
the recall module is configured to:
perform, according to the key field and the expansion word, the semantic recall in the knowledge base, where the semantic recall is used to query a knowledge document including a second similar field in the knowledge base, and a semantic similarity between the second similar field and the key field or the expansion word is greater than the preset threshold;
the retrieval module is configured to:
perform, according to the key field and the expansion word, the matching retrieval in the knowledge base, where the matching retrieval is used to retrieve a knowledge document including the key field or the expansion word in the knowledge base.

In a possible implementation, the business knowledge document in the knowledge base is stored in the following manner:
acquiring a plurality of business knowledge documents through different channels;
performing a splitting processing on each of the business knowledge documents to obtain a business knowledge fragment;
performing a vectorization processing on the business knowledge fragment to obtain a knowledge fragment vector; and
storing the knowledge fragment vector into the knowledge base.

Based on the same concept, an embodiment of the present disclosure further provides a computer-readable medium having a computer program stored thereon, where the program, when executed by a processing apparatus, implements the steps of any of the above knowledge question-answering method.

Based on the same concept, an embodiment of the present disclosure further provides an electronic device, which may include:
a storage apparatus having a computer program stored thereon; and
a processing apparatus, configured to execute the computer program in the storage apparatus to implement the steps of any of the above knowledge question-answering method.

Based on the same concept, an embodiment of the present disclosure further provides a computer program product, including a computer program, where the computer program, when executed by a processor, implements the steps of any of the above knowledge question-answering method.

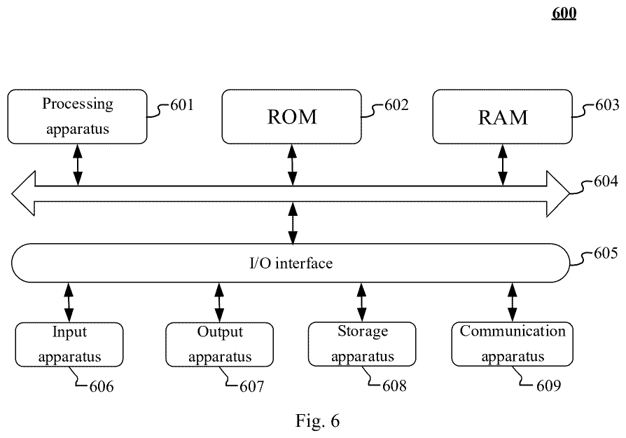

Reference is made to FIG. 6 below, which illustrates a structure diagram of an electronic device 600 suitable for implementing the embodiments of the present disclosure. The terminal device in the embodiments of the present disclosure may include, but is not limited to, mobile terminals such as a mobile phone, a laptop, a digital broadcast receiver, a PDA (Personal Digital Assistant), a tablet computer, a PMP (Portable Multimedia Player), a vehicle-mounted terminal (such as a vehicle-mounted navigation terminal), and fixed terminals such as a digital TV and a desktop computer. The electronic device shown in FIG. 6 is only an example and should not impose any limitation to the functions and usage scope of the embodiments of the present disclosure.

As shown in FIG. 6, the electronic device 600 may include a processing apparatus 601 (such as a central processing unit, a graphics processor, etc.), which may perform various appropriate actions and processes according to a program stored in a read-only memory (ROM) 602 or a program loaded from a storage apparatus 608 into a random access memory (RAM) 603. The RAM 603 further stores various programs and data required for operations of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, a gyroscope, etc.; an output apparatus 607 including, for example, a liquid crystal display (LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 6 illustrates the electronic device 600 having various apparatuses, it should be understood that it is not required to implement or have all the illustrated apparatuses. Alternatively, more or fewer apparatuses may be implemented or provided.

In particular, according to the embodiments of the present disclosure, the process described above with reference to the flowchart can be implemented as a computer software program. For example, an embodiment of the present disclosure includes a computer program product, which includes a computer program carried on a non-transitory computer-readable medium, and the computer program includes program codes for executing the method shown in the flowchart. In such an embodiment, the computer program may be downloaded and installed from the network through the communication apparatus 609, or installed from the storage apparatus 608, or installed from the ROM 602. When the computer program is executed by the processing apparatus 601, the above functions defined in the method of the embodiments of the present disclosure are executed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program, and the program may be used by or in combination with an instruction execution system, apparatus or device. In the present disclosure, the computer-readable signal medium may include a data signal propagated in a baseband or as a part of a carrier wave, in which a computer-readable program code is carried. The data signal propagated in this manner may be in various forms, including but not limited to an electromagnetic signal, an optical signal, or any suitable combination thereof. The computer-readable signal medium may also be any computer-readable medium other than the computer-readable storage medium. The computer-readable signal medium may send, propagate or transmit a program used by or in combination with an instruction execution system, apparatus or device. The program code contained on the computer-readable medium may be transmitted by any suitable medium, including but not limited to an electric wire, an optical cable, RF (radio frequency), etc., or any suitable combination thereof.

In some implementations, any currently known or future developed network protocol such as HTTP (HyperText Transfer Protocol) may be used for communication, and may be interconnected with any form or medium of digital data communication (for example, a communication network). Examples of the communication network include a local area network (“LAN”), a wide area network (“WAN”), an internet (for example, the Internet) and a peer-to-peer network (for example, an ad hoc peer-to-peer network), as well as any currently known or future developed network.

The above computer-readable medium may be included in the above electronic device, or may exist alone without being assembled into the electronic device.

The above computer-readable medium carries one or more programs, and when the above one or more programs are executed by the electronic device, the electronic device is caused to: acquire a target question input by a user in a natural language; retrieve, through a machine learning model, in a knowledge base according to the target question to obtain a target knowledge document for answering the target question, and determine, based on the target knowledge document, a target answer for the target question, where the knowledge base is used to store a business knowledge document; and display the target answer to the user.

The computer program codes for executing the operations of the present disclosure may be written in one or more programming languages or a combination thereof. The above programming languages include object-oriented programming languages such as Java, Smalltalk, and C++, as well as conventional procedural programming languages such as C or similar programming languages. The program code may be executed entirely on a user's computer, partly on a user's computer, as a stand-alone software package, partly on a user's computer and partly on a remote computer, or entirely on a remote computer or server. In the case of a remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, and the module, the program segment, or the portion of codes contains one or more executable instructions for implementing a specified logical function. It should also be noted that in some alternative implementations, the functions marked in the blocks may occur in a different order than the order marked in the drawings. For example, two blocks shown in succession may, in fact, be executed substantially concurrently, or the blocks may sometimes be executed in a reverse order, depending upon the functionality involved. It should also be noted that each block of the block diagrams and/or flowcharts, and a combination of blocks in the block diagrams and/or flowcharts, may be implemented by a dedicated hardware-based system that performs the specified functions or operations, or may also be implemented by a combination of dedicated hardware and computer instructions.

The modules involved in the embodiments of the present disclosure may be implemented by software or hardware. The name of the module does not constitute a limitation to the module itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium include an electrical connection with one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The above description is only preferred embodiments of the present disclosure and explanations of the applied technical principles. Those skilled in the art should understand that the disclosure scope involved in the present disclosure is not limited to the technical solution formed by the specific combination of the above technical features, and should also cover other technical solutions formed by any combination of the above technical features or equivalent features thereof without departing from the above disclosure concept. For example, a technical solution formed by replacing the above features with technical features with similar functions disclosed in the present disclosure (but not limited to).

In addition, although operations are described in a specific order, this should not be understood as requiring these operations to be performed in the specific order shown or in a sequential order. Under certain circumstances, multitasking and parallel processing may be advantageous. Likewise, although several specific implementation details are included in the above discussion, these should not be interpreted as limiting the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of methods, it should be understood that the subject matter defined in the appended claims is not necessarily limited to the specific features or actions described above. Rather, the specific features and actions described above are merely example forms for implementing the claims. Regarding the apparatus in the above embodiments, the specific manners in which the individual modules perform operations have been described in detail in the embodiments related to the method, and will not be described in detail here.

1. A knowledge question-answering method, comprising:
acquiring a target question input by a user in a natural language;
retrieving, through a machine learning model, in a knowledge base according to the target question to obtain a target knowledge document for answering the target question, and determining, based on the target knowledge document, a target answer for the target question, wherein the knowledge base is used to store a business knowledge document; and
displaying the target answer to the user.

2. The knowledge question-answering method according to claim 1, wherein a plurality of target knowledge documents are provided, and the determining, based on the target knowledge document, a target answer for the target question, comprises:
determining content relevance between the target question and each of the plurality of target knowledge documents;
determining a preset number of knowledge documents from the plurality of target knowledge documents according to the content relevance, wherein content relevance corresponding to each of the preset number of knowledge documents is greater than content relevance corresponding to each of knowledge documents other than the preset number of knowledge documents in the plurality of target knowledge documents; and
determining the target answer for the target question according to the preset number of knowledge documents.

3. The knowledge question-answering method according to claim 2, wherein the determining content relevance between the target question and each of the plurality of target knowledge documents, comprises:
inputting the target question and the plurality of target knowledge documents into a relevance model to obtain the content relevance between the target question and each of the target knowledge documents, wherein the relevance model is configured to output, according to an input question and an input knowledge document, content relevance between the input question and the input knowledge document.

4. The knowledge question-answering method according to claim 1, wherein the determining, based on the target knowledge document, a target answer for the target question, comprises:
generating a target prompt based on the target knowledge document, the target question, and a preset prompt template, wherein the target prompt is used to instruct the machine learning model to determine, based on the target knowledge document, the target answer for the target question; and
inputting the target prompt into the machine learning model to obtain the target answer for the target question.

5. The knowledge question-answering method according to claim 1, wherein the retrieving, through a machine learning model, in a knowledge base according to the target question to obtain a target knowledge document for answering the target question, comprises:
extracting a key field in the target question through the machine learning model;
performing, at least according to the key field, a semantic recall in the knowledge base to obtain a first knowledge document, wherein the semantic recall is used to query a knowledge document comprising a first similar field in the knowledge base, and a semantic similarity between the first similar field and the key field is greater than a preset threshold; and
performing, at least according to the key field, a matching retrieval in the knowledge base to obtain a second knowledge document, wherein the matching retrieval is used to query a knowledge document comprising the key field in the knowledge base;
wherein the target knowledge document comprises the first knowledge document and the second knowledge document.

6. The knowledge question-answering method according to claim 5, further comprising:
determining an expansion word with a same semantics as the key field;
wherein the performing, at least according to the key field, a semantic recall in the knowledge base, comprises:
performing, according to the key field and the expansion word, the semantic recall in the knowledge base, wherein the semantic recall is used to query a knowledge document comprising a second similar field in the knowledge base, and a semantic similarity between the second similar field and the key field or a semantic similarity between the second similar field and the expansion word is greater than the preset threshold;
wherein the performing, at least according to the key field, a matching retrieval in the knowledge base, comprises:
performing, according to the key field and the expansion word, the matching retrieval in the knowledge base, wherein the matching retrieval is used to retrieve a knowledge document comprising the key field or the expansion word in the knowledge base.

7. The knowledge question-answering method according to claim 1, wherein the business knowledge document in the knowledge base is stored in a following manner:
acquiring a plurality of business knowledge documents through different channels;
performing a splitting processing on each of the plurality of business knowledge documents to obtain a business knowledge fragment;
performing a vectorization processing on the business knowledge fragment to obtain a knowledge fragment vector; and
storing the knowledge fragment vector into the knowledge base.

8. A non-transitory computer-readable medium having a computer program stored thereon, wherein the non-transitory computer program, when executed by a processing apparatus, implements a knowledge question-answering method;
wherein the knowledge question-answering method comprises:
acquiring a target question input by a user in a natural language;
retrieving, through a machine learning model, in a knowledge base according to the target question to obtain a target knowledge document for answering the target question, and determining, based on the target knowledge document, a target answer for the target question, wherein the knowledge base is used to store a business knowledge document; and
displaying the target answer to the user.

9. The non-transitory computer-readable medium according to claim 8, wherein a plurality of target knowledge documents are provided, and the determining, based on the target knowledge document, a target answer for the target question, comprises:
determining content relevance between the target question and each of the plurality of target knowledge documents;
determining a preset number of knowledge documents from the plurality of target knowledge documents according to the content relevance, wherein content relevance corresponding to each of the preset number of knowledge documents is greater than content relevance corresponding to each of knowledge documents other than the preset number of knowledge documents in the plurality of target knowledge documents; and
determining the target answer for the target question according to the preset number of knowledge documents.

10. The non-transitory computer-readable medium according to claim 9, wherein the determining content relevance between the target question and each of the plurality of target knowledge documents, comprises:
inputting the target question and the plurality of target knowledge documents into a relevance model to obtain the content relevance between the target question and each of the target knowledge documents, wherein the relevance model is configured to output, according to an input question and an input knowledge document, content relevance between the input question and the input knowledge document.

11. The non-transitory computer-readable medium according to claim 8, wherein the determining, based on the target knowledge document, a target answer for the target question, comprises:
generating a target prompt based on the target knowledge document, the target question, and a preset prompt template, wherein the target prompt is used to instruct the machine learning model to determine, based on the target knowledge document, the target answer for the target question; and
inputting the target prompt into the machine learning model to obtain the target answer for the target question.

12. The non-transitory computer-readable medium according to claim 8, wherein the retrieving, through a machine learning model, in a knowledge base according to the target question to obtain a target knowledge document for answering the target question, comprises:
extracting a key field in the target question through the machine learning model;
performing, at least according to the key field, a semantic recall in the knowledge base to obtain a first knowledge document, wherein the semantic recall is used to query a knowledge document comprising a first similar field in the knowledge base, and a semantic similarity between the first similar field and the key field is greater than a preset threshold; and
performing, at least according to the key field, a matching retrieval in the knowledge base to obtain a second knowledge document, wherein the matching retrieval is used to query a knowledge document comprising the key field in the knowledge base;
wherein the target knowledge document comprises the first knowledge document and the second knowledge document.

13. The non-transitory computer-readable medium according to claim 12, wherein the knowledge question-answering method further comprises:
determining an expansion word with a same semantics as the key field;
wherein the performing, at least according to the key field, a semantic recall in the knowledge base, comprises:
performing, according to the key field and the expansion word, the semantic recall in the knowledge base, wherein the semantic recall is used to query a knowledge document comprising a second similar field in the knowledge base, and a semantic similarity between the second similar field and the key field or a semantic similarity between the second similar field and the expansion word is greater than the preset threshold;
wherein the performing, at least according to the key field, a matching retrieval in the knowledge base, comprises:
performing, according to the key field and the expansion word, the matching retrieval in the knowledge base, wherein the matching retrieval is used to retrieve a knowledge document comprising the key field or the expansion word in the knowledge base.

14. The non-transitory computer-readable medium according to claim 8, wherein the business knowledge document in the knowledge base is stored in a following manner:
acquiring a plurality of business knowledge documents through different channels;
performing a splitting processing on each of the plurality of business knowledge documents to obtain a business knowledge fragment;
performing a vectorization processing on the business knowledge fragment to obtain a knowledge fragment vector; and
storing the knowledge fragment vector into the knowledge base.

15. An electronic device, characterized by comprising:
a storage apparatus having a computer program stored thereon; and
a processing apparatus, configured to execute the computer program in the storage apparatus to implement a knowledge question-answering method;
wherein the knowledge question-answering method comprises:
acquiring a target question input by a user in a natural language;
retrieving, through a machine learning model, in a knowledge base according to the target question to obtain a target knowledge document for answering the target question, and determining, based on the target knowledge document, a target answer for the target question, wherein the knowledge base is used to store a business knowledge document; and
displaying the target answer to the user.

16. The electronic device according to claim 15, wherein a plurality of target knowledge documents are provided, and the determining, based on the target knowledge document, a target answer for the target question, comprises:
determining content relevance between the target question and each of the plurality of target knowledge documents;
determining a preset number of knowledge documents from the plurality of target knowledge documents according to the content relevance, wherein content relevance corresponding to each of the preset number of knowledge documents is greater than content relevance corresponding to each of knowledge documents other than the preset number of knowledge documents in the plurality of target knowledge documents; and
determining the target answer for the target question according to the preset number of knowledge documents.

17. The electronic device according to claim 16, wherein the determining content relevance between the target question and each of the plurality of target knowledge documents, comprises:
inputting the target question and the plurality of target knowledge documents into a relevance model to obtain the content relevance between the target question and each of the target knowledge documents, wherein the relevance model is configured to output, according to an input question and an input knowledge document, content relevance between the input question and the input knowledge document.

18. The electronic device according to claim 15, wherein the determining, based on the target knowledge document, a target answer for the target question, comprises:
generating a target prompt based on the target knowledge document, the target question, and a preset prompt template, wherein the target prompt is used to instruct the machine learning model to determine, based on the target knowledge document, the target answer for the target question; and
inputting the target prompt into the machine learning model to obtain the target answer for the target question.

19. The electronic device according to claim 15, wherein the retrieving, through a machine learning model, in a knowledge base according to the target question to obtain a target knowledge document for answering the target question, comprises:
extracting a key field in the target question through the machine learning model;
performing, at least according to the key field, a semantic recall in the knowledge base to obtain a first knowledge document, wherein the semantic recall is used to query a knowledge document comprising a first similar field in the knowledge base, and a semantic similarity between the first similar field and the key field is greater than a preset threshold; and
performing, at least according to the key field, a matching retrieval in the knowledge base to obtain a second knowledge document, wherein the matching retrieval is used to query a knowledge document comprising the key field in the knowledge base;
wherein the target knowledge document comprises the first knowledge document and the second knowledge document.

20. The electronic device according to claim 15, wherein the knowledge question-answering method further comprises:
determining an expansion word with a same semantics as the key field;
wherein the performing, at least according to the key field, a semantic recall in the knowledge base, comprises:
performing, according to the key field and the expansion word, the semantic recall in the knowledge base, wherein the semantic recall is used to query a knowledge document comprising a second similar field in the knowledge base, and a semantic similarity between the second similar field and the key field or a semantic similarity between the second similar field and the expansion word is greater than the preset threshold;
wherein the performing, at least according to the key field, a matching retrieval in the knowledge base, comprises:
performing, according to the key field and the expansion word, the matching retrieval in the knowledge base, wherein the matching retrieval is used to retrieve a knowledge document comprising the key field or the expansion word in the knowledge base.
